(19) United States
(12) Patent Application Publication
(10) Pub. No.: US 2022/0239129 A1
(43) Pub. Date: Jul. 28, 2022

(54) HYBRID BATTERY MANAGEMENT SYSTEM FOR UNMANNED AERIAL VEHICLES

(71) Applicant: AR2E LLC, Cherry Hill, NJ (US)

(72) Inventors: Andrew Winkler, Cherry Hill, NJ (US); Ryan Archer, Tuckerton, NJ (US)

(21) Appl. No.: 17/584,594

(22) Filed: Jan. 26, 2022

Related U.S. Application Data
(60) Provisional application No. 63/141,781, filed on Jan. 26, 2021.

(51) Int. Cl. H02J 7/00; H02J 3/00; B64C 39/02; B60L 58/18; G05B 15/02; H01M 10/0525; H01M 10/42

(52) U.S. Cl. CPC H02J 7/0047; H02J 7/0013; H02J 7/0063; H02J 3/003; B64C 39/024; B60L 58/18; H01M 2010/4271; H01M 10/0525; H01M 10/425; H02J 2310/44; B60L 2200/10; B64C 2201/00; H01M 2220/20; G05B 15/02

(57) ABSTRACT

A system and method for UAV power management includes a processor for monitoring power loads in the UAV and switching power sources based on a load profile in real time. The system may monitor flight phases or issued commands to proactively switch power sources in anticipation of an eminent change in the load profile.

### PRIORITY

The present application claims the benefit under 35 U.S.C. § 119(e) of U.S. Provisional App. No. 63/141781 (filed Jan. 26, 2021), which is incorporated herein by reference.

### BACKGROUND

Power loads of unmanned aerial vehicles (UAVs) differ based on activity (such as flight phase). Climbing to altitude or intermittent use of high-power payloads puts a heavy load on a power supply, while cruising or loitering puts a substantially less load on the power supply. Lithium Polymer (LiPo) batteries can handle high load applications but are less optimized for low load activities while lithium ion (Li-Ion) batteries handle low, consistent loads well but perform poorly at high power.

### SUMMARY

In one aspect, embodiments of the inventive concepts disclosed herein are directed to a system and method for monitoring power loads in a UAV and switching power sources based on a load profile in real time.

In a further aspect, the system monitors flight phases or issued commands to proactively switch power sources in anticipation of an eminent change in the load profile.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 shows a block diagram of a system according to an exemplary embodiment; and

FIG. 2 shows a flowchart of a method according to an exemplary embodiment.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a system and method for monitoring power loads in a UAV and switching power sources based on a load profile in real time. The system may monitor flight phases (take off, landing, cruise, etc.) or issued commands to proactively switch power sources in anticipation of an eminent change in the load profile.

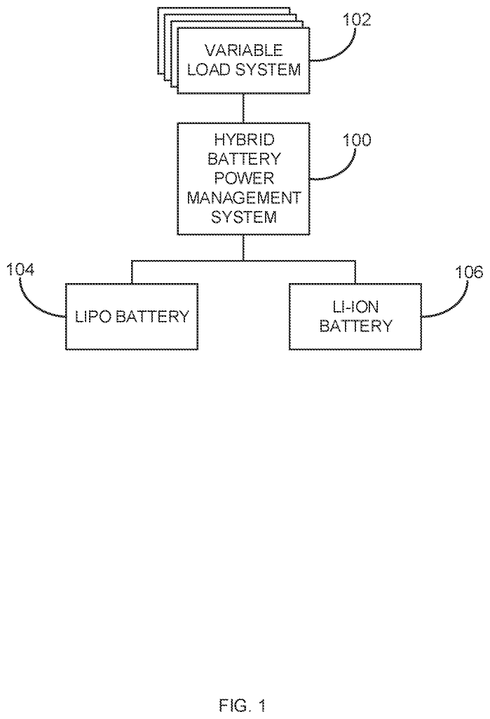

Referring to FIG. 1, a block diagram of a system according to an exemplary embodiment is shown. The system includes a hybrid battery power management system 100 having a processor and at least one switch. The hybrid battery power management system 100 is configured to monitor a power load from one or more variable load systems 102 such as motors, sensors, radios, etc. The hybrid battery power management system 100 may store a set of load profiles corresponding to various power draw scenarios of the variable load systems 102.

The hybrid battery power management system 100 is connected to two or more power sources 104, 106. In at least one embodiment, the power sources 104, 106 may comprise a LiPo battery 104 and a Li-Ion battery 106. Each of the set of load profiles may be associated with one of the power sources 104, 106 where the associated power source 104, 106 is adapted to be relatively more efficient with respect to the specific load profile. For example, when the UAV is climbing for an extended period, the variable load systems 102 may draw a lot of power in a relatively short period of time; such task is well suited for LiPo batteries 104. In such conditions, the hybrid battery power management system 100 would switch to powering the variable load systems 102 from the LiPo batteries 104. Alternatively, when the UAV enters a low power state like cruising at altitude or loitering, the hybrid battery power management system 100 would switch to the Li-Ion batteries 106.

In at least one embodiment, the hybrid battery power management system 100 may perform housekeeping activities to optimize load between the power sources 104, 106 to extend endurance and improve overall power source health and life.

In at least one embodiment, the hybrid battery power management system 100 may continuously record power usage, the current status of each variable load system 102, and control signals received from external systems. The hybrid battery power management system associates the recorded values with each other into a new load profile which may be defined by instantaneous values, values averaged over time, or derivative values (rate of change of said values over time). The new profile may then be associated with a power source 104, 106 best suited to such load profile.

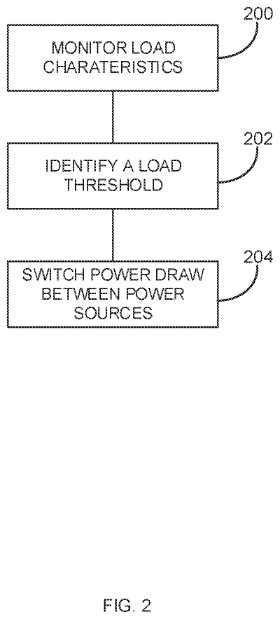

Referring to FIG. 2, a flowchart of a method according to an exemplary embodiment is shown. A processor continuously monitors 200 load characteristics of various on-board electronic components and compares the load characteristics to a stored set of load characteristic profiles. Each load characteristic profile is associated with a preferred power source adapted for more efficient use under those load characteristics. The processor identifies 202 the load characteristic profile based on the comparison and switches 204 between power sources to the preferred power source as defined by the corresponding load characteristic profile.

In at least one embodiment, the processor may also receive control signals or corresponding data from one or more flight control systems. Based on those control signals, the processor may identify an eminent power load change and switch to the preferred power source of for the corresponding near future load characteristic profile. In at least one embodiment, such identification may be accomplished by a trained neural network of other artificial intelligence based on a data set of control signals and subsequent load characteristics. For example, certain control signals may be associated with an extended climb period in the near future; the processor may then switch the power supply to LiPo batteries to avoid power interruption during the extended climb period.

It is believed that the inventive concepts disclosed herein and many of their attendant advantages will be understood by the foregoing description of embodiments of the inventive concepts disclosed, and it will be apparent that various changes may be made in the form, construction, and arrangement of the components thereof without departing from the broad scope of the inventive concepts disclosed herein or without sacrificing all of their material advantages; and individual features from various embodiments may be combined to arrive at other embodiments. The form herein before described being merely an explanatory embodiment thereof, it is the intention of the following claims to encompass and include such changes. Furthermore, any of the features disclosed in relation to any of the individual embodiments may be incorporated into any other embodiment.

What is claimed is:

1. An unmanned aerial vehicle comprising:
one or more electrical components;
at least two batteries; and
a battery management element including a processor configured via non-transitory processor executable code configuring the processor to:
continuously monitor a load from the one or more electronic components;
compare the load to a set of load profiles, each corresponding to a preferred battery in the at least two batteries; and
switch between the at least two batteries base on the load.

2. The unmanned aerial vehicle of claim 1, wherein the at least two batteries comprise a set of LiPo batteries and a set of Li-Ion batteries.

3. The unmanned aerial vehicle of claim 2, wherein the set of load profiles comprises at least a load profile corresponding to an extended climb period and a load profile corresponding to a cruising period.

4. The unmanned aerial vehicle of claim 3, wherein the load profile corresponding to an extended climb period is associated with the LiPo batteries and the load profile corresponding to a cruising period is associated with the Li-Ion batteries.

5. The unmanned aerial vehicle of claim 1, wherein the processor is further configured to:
receive one or more control signals; and
identify a load profile in the set of load profiles based on the one or more control signals.

6. The unmanned aerial vehicle of claim 5, wherein:
the load profile in the set of load profiles based on the one or more control signals comprises a near future load profile corresponding to a load profile that the unmanned aerial vehicle will experience in the near future; and
the processor is further configured to switch between the batteries based on the near future load profile.

7. The unmanned aerial vehicle of claim 1, wherein one or more of the load profiles in the set of load profiles are associated with a unique flight phase.

8. A power management system for unmanned aerial vehicles comprising:
one or more electrical components;
at least two batteries; and
a processor configured via non-transitory processor executable code configuring the processor to:
continuously monitor a load from the one or more electronic components;
compare the load to a set of load profiles, each corresponding to a preferred battery in the at least two batteries; and
switch between the at least two batteries base on the load.

9. The power management system of claim 8, wherein the at least two batteries comprise a set of LiPo batteries and a set of Li-Ion batteries.

10. The power management system of claim 9, wherein the set of load profiles comprises at least a load profile corresponding to an extended climb period and a load profile corresponding to a cruising period.

11. The power management system of claim 10, wherein the load profile corresponding to an extended climb period is associated with the LiPo batteries and the load profile corresponding to a cruising period is associated with the Li-Ion batteries.

12. The power management system of claim 8, wherein the processor is further configured to:
receive one or more control signals; and
identify a load profile in the set of load profiles based on the one or more control signals.

13. The power management system of claim 12, wherein:
the load profile in the set of load profiles based on the one or more control signals comprises a near future load profile corresponding to a load profile that the power management system will experience in the near future; and
the processor is further configured to switch between the batteries based on the near future load profile.

14. The power management system of claim 8, wherein the processor is further configured to:
continuously record power usage, a current status of each electrical component, and control signals;
associate the recorded power usage, current status of each electrical component, and control signals into a new load profile; and
associate the new load profile with one of the batteries according to recorded power usage.

15. A method of power management for unmanned aerial vehicles comprising:
continuously monitoring a load from one or more electronic components;
comparing the load to a set of load profiles, each corresponding to a preferred battery in the at least two batteries; and
switching between the at least two batteries base on the load profile.

16. The method of power management of claim 15, wherein the set of load profiles comprises at least a load profile corresponding to an extended climb period and a load profile corresponding to a cruising period.

17. The method of power management of claim 16, wherein the load profile corresponding to an extended climb period is associated with a set of LiPo batteries and the load profile corresponding to a cruising period is associated with a set of Li-Ion batteries.

18. The method of power management of claim 15, further comprising:
receiving one or more control signals; and
identifying a load profile in the set of load profiles based on the one or more control signals.

19. The method of power management of claim 18, wherein:
the load profile in the set of load profiles based on the one or more control signals comprises a near future load profile corresponding to a predicted load profile that the unmanned aerial vehicle will experience in the near future; and
further comprising switching between the batteries based on the near future load profile.

20. The method of power management of claim 15, further comprising:
continuously recording power usage, a current status of each electrical component, and control signals;
associating the recorded power usage, current status of each electrical component, and control signals into a new load profile; and
associating the new load profile with one of the batteries according to recorded power usage.
